(19) United States
(12) Patent Application Publication
(10) Pub. No.: US 2006/0027555 A1
(43) Pub. Date: Feb. 9, 2006

(54) Low cost heating elements for cooking applications manufactured from conductive loaded resin-based materials

(75) Inventor: Thomas Aisenbrey, Littleton, CO (US)

Correspondence Address: THOMAS AISENBREY, 28 DAVIS AVENUE, POUGHKEEPSIE, NY, 12603, US

(73) Assignee: Integral Technologies, Inc.

(21) Appl. No.: 11/244,961

(22) Filed: Oct. 6, 2005

Related U.S. Application Data
(60) Provisional application No. 60/616,517, filed on Oct. 6, 2004.

(30) Foreign Application Priority Data
Jun. 25, 2004 (JP) 10/877,092

(51) Int. Cl. F27D 11/00

(52) U.S. Cl. 219/385

(57) ABSTRACT

Heating elements for cooking appliances are formed of a conductive loaded resin-based material. The conductive loaded resin-based material comprises micron conductive powder(s), conductive fiber(s), or a combination of conductive powder and conductive fibers in a base resin host. The percentage by weight of the conductive powder(s), conductive fiber(s), or a combination thereof is between about 20% and 50% of the weight of the conductive loaded resin-based material. The micron conductive powders are metals or conductive non-metals or metal plated non-metals. The micron conductive fibers may be metal fiber or metal plated fiber. Further, the metal plated fiber may be formed by plating metal onto a metal fiber or by plating metal onto a non-metal fiber. Any platable fiber may be used as the core for a non-metal fiber. Superconductor metals may also be used as micron conductive fibers and/or as metal plating onto fibers in the present invention.

### RELATED PATENT APPLICATIONS

This Patent Application claims priority to the U.S. Provisional Patent Application 60/616,517, filed on Oct. 6, 2005, which is herein incorporated by reference in its entirety.

This Patent application is a Continuation-in-Part of INT01-002CIPC, filed as U.S. patent application Ser. No. 10/877,092, filed on Jun. 25, 2004, which is a Continuation of INT01-002CIP, filed as U.S. patent application Ser. No. 10/309,429, filed on Dec. 4, 2002, now issued as U.S. Pat. No. 6,870,516, also incorporated by reference in its entirety, which is a Continuation-in-Part application of docket number INT01-002, filed as U.S. patent application Ser. No. 10/075,778, filed on Feb. 14, 2002, now issued as U.S. Pat. No. 6,741,221, which claimed priority to U.S. Provisional Patent Applications Ser. No. 60/317,808, filed on Sep. 7, 2001, Ser. No. 60/269,414, filed on Feb. 16, 2001, and Ser. No. 60/268,822, filed on Feb. 15, 2001, all of which are incorporated by reference in their entirety.

### BACKGROUND OF THE INVENTION

(1) Field of the Invention

This invention relates to heating elements for cooking applications and, more particularly, to heating elements for cooking applications molded of conductive loaded resin-based materials comprising micron conductive powders, micron conductive fibers, or a combination thereof, substantially homogenized within a base resin when molded. This manufacturing process yields a conductive part or material usable within the EMF, thermal, acoustic, or electronic spectrum(s).

(2) Description of the Prior Art

Most cooking appliances require a heating source. Typical heating sources include natural gas, microwave energy and electrical resistive heating. Resistive heating elements used in various heating systems and applications have advantages over, for example, combustion-based heating sources. Electric heating elements do not generate noxious or asphyxiating fumes. Electric heating elements may be precisely controlled by electrical signals and, further, by digital circuits. Electrical heating elements can be formed into many shapes. Very focused heating can be created with minimal heat exposure for nearby objects. Heating can be performed in the absence of oxygen. Fluids, even combustible fluids, can be heated by properly designed resistive heating elements. Therefore, electrical resistive heating is frequently chosen where the convenience of electrical portability and the elimination of open flame are required. Electric skillets, for example, contain an electric heating element that converts electrical power, typically alternative current (AC), into heat.

Most electric heating elements are highly resistive metal wire, such as nickel-chromium (nichrome) or tungsten, designed to provide the necessary resistance for the heating required. The resistance of the heating element is determined by the resistivity of the wire, its cross-sectional area, and its length. The heat generated by the heating element is determined by the current passing through the heating element. Typically, the heating element further comprises an outer layer of a material that serves as an electrical insulator and a thermal conductor.

Heat generated in a resistive heating element is transferred to heated objects by conduction, convection and/or radiation. Conduction heat transfer relies on direct contact between the heating element and the heated object. For example, the transfer of heat from an electric range to a metal pan is essentially by conduction. Convection heat transfer relies on fluid flow to transfer heat. For example, an egg cooking a pan of boiling water relies on convection currents to transfer heat from the metal pan through the water and to the egg. Water at the bottom of the pan is superheated causing it to lose density such that it rises. This rising superheated water transfers heat energy to the egg floating in the water. Conversely, the water at the top of the pan is cooler and denser and, therefore, falls to toward the bottom of the pan. A convection current is thereby established in the pan of water. Radiation heat transfer relies on electromagnetic energy (such as light) to transfer heat from the heating element to the object. For example, a cake baking in an electric oven will be heated, in part, by the radiated heat from the glowing heating element. Radiant heating in how the sun's energy reaches the earth. In practical application, the three means of thermal transfer are found to interact and to frequently occur at the same time.

However, resistive heating elements currently used in the art have disadvantages. Metal-based elements, and particularly nichrome and tungsten, can be brittle and therefore not suitable for applications requiring a flexible heating element. Further, the large thermal cycles inherent in many product applications and the brittleness of these materials will cause thermal fatigue. Other metal elements, such as copper-based elements, bring greater flexibility. However, if the application requires the resistive element to change or flex positions, then the resistive element will tend to wear out due to metal fatigue. Metal-based resistive heating elements are typically formed as metal wires. These elements are expensive, can require very high temperature processing, and are limited in shape. In addition, when a breakage occurs, typically due to fatigue as described above, then the entire element stops working and must be replaced.

Several prior art inventions relate to electric heating elements and, more particularly, to heating elements comprising conductive plastics or other resin-based materials. U.S. Pat. No. 4,844,048 to Aruga et al teaches a bread baking appliance that mixes the ingredients and bakes a loaf of bread at a time. U.S. Patent Publication U.S. 2004/0035843 A1 to Hamilton et al teaches a large area alumina ceramic heater useful for household and industrial cooking surfaces, self-heating pots, and toner fusers for electro photography. U.S. Pat. No. 4,808,470 to Geuskens et al teaches a heating element and method of manufacture that utilizes a thermo hardened synthetic resin which is stable up to a temperature of about 500° that comprises between 7 to 13 percent carbon black by weight as the conductive element. U.S. Pat. No. 6,483,087 to Gardner et al teaches a thermoplastic laminate fabric heater and method of manufacture that utilizes nickel-coated carbon fibers for the electrically conductive fabric layer.

U.S. Patent Publication U.S. 2002/0017516 A1 to McKeen et al teaches a cooking device with a disposable insert utilizing a disposable insert of metal foil substrate coated with a nonstick polymer resin. This invention teaches of a clam-shell or double platen cooker typically associated with cooking a hamburger or waffle. U.S. Pat. No. 6,085,442 to Erickson teaches a food dehydrator that utilizes a series of coiled heating wires as the heater element in the blower assembly. U.S. Pat. No. 4,798,937 to Guerrero teaches a warmer plate cover for a coffee brewer manufactured out of a synthetic resin polymer that is heat resistant such as TEFLON. The invention also teaches that the polymer cover helps to protect the glass coffee pot from breaking and more evenly distributes the heat from the heating element. U.S. Pat. No. 4,115,918 to Anderl et al teaches a method of making an appliance with intermittently staked sheathed heating elements such as one would find in a small household deep fat fryer to help overcome the problems with the rapid temperature rise in an appliance. U.S. Pat. No. 4,569,851 to Schultz teaches a compact tortilla press and oven unit that utilizes a plurality of gas burners beneath the each of the disks as the heat source for toasting the tortillas. This invention also teaches of the possibility of resistance heater elements located on or in the proximity of the disks for the toasting process.

### SUMMARY OF THE INVENTION

A principal object of the present invention is to provide an effective heating element for a cooking appliance.

A further object of the present invention is to provide a method to form a heating element for a cooking appliance.

A further object of the present invention is to provide a heating element molded of conductive loaded resin-based materials.

A yet further object of the present invention is to provide a cooking appliance comprising a conductive loaded resin-based heating element.

A yet further object of the present invention is to provide a toaster cooking appliance comprising a conductive loaded resin-based heating element.

A yet further object of the present invention is to provide a waffle iron cooking appliance comprising a conductive loaded resin-based heating element.

A yet further object of the present invention is to provide a tortilla press cooking appliance comprising a conductive loaded resin-based heating element.

A yet further object of the present invention is to provide a griddle cooking appliance comprising a conductive loaded resin-based heating element.

A yet further object of the present invention is to provide an indoor grill cooking appliance comprising a conductive loaded resin-based heating element.

A yet further object of the present invention is to provide a heating element for a cooking appliance molded of conductive loaded resin-based material where the electrical or thermal characteristics can be altered or the visual characteristics can be altered by forming a metal layer over the conductive loaded resin-based material.

A yet further object of the present invention is to provide methods to fabricate a heating element for a cooking appliance from a conductive loaded resin-based material incorporating various forms of the material.

In accordance with the objects of this invention, a cooking appliance device is achieved. The device comprises a heating element comprising a conductive loaded, resin-based material comprising conductive materials in a base resin host. A heat plate contacts the heating element on a first surface and has a second surface useful for cooking.

Also in accordance with the objects of this invention, a cooking appliance device is achieved. The device comprises a heating element comprising a conductive loaded, resin-based material comprising micron conductive fiber in a base resin host. The percent by weight of the micron conductive fiber is between 20% and 50% of the total weight. A heat plate contacts the heating element on a first surface and has a second surface useful for cooking.

Also in accordance with the objects of this invention, a method to form a cooking appliance is achieved. The method comprises providing a conductive loaded, resin-based material comprising micron conductive fiber in a resin-based host. A heat plate is provided. The conductive loaded, resin-based material is molded into a heating element. The heat plate is contacted to the heating element.

### BRIEF DESCRIPTION OF THE DRAWINGS

In the accompanying drawings forming a material part of this description, there is shown:

FIG. 1 illustrates a first preferred embodiment of the present invention showing a waffle iron cooking appliance having a heating element comprising the conductive loaded resin-based material.

FIG. 2 illustrates a first preferred embodiment of a conductive loaded resin-based material wherein the conductive materials comprise a powder.

FIG. 3 illustrates a second preferred embodiment of a conductive loaded resin-based material wherein the conductive materials comprise micron conductive fibers.

FIG. 4 illustrates a third preferred embodiment of a conductive loaded resin-based material wherein the conductive materials comprise both conductive powder and micron conductive fibers.

FIGS. 5a and 5b illustrate a fourth preferred embodiment wherein conductive fabric-like materials are formed from the conductive loaded resin-based material.

FIGS. 6a and 6b illustrate, in simplified schematic form, an injection molding apparatus and an extrusion molding apparatus that may be used to mold heating elements for cooking devices of a conductive loaded resin-based material.

FIG. 7 illustrates a second preferred embodiment of the present invention showing a toaster with heating elements formed of a conductive loaded resin-based material.

FIG. 8 illustrates a third preferred embodiment of the present invention showing a tortilla press with heating elements formed of a conductive loaded resin-based material.

FIG. 9 illustrates a fourth preferred embodiment of the present invention showing an electric griddle with a heating element formed of a conductive loaded resin-based material.

FIG. 10 illustrates a fifth preferred embodiment of the present invention showing an indoor electric grill with heating elements formed of a conductive loaded resin-based material.

FIG. 11 illustrates a sixth preferred embodiment of the present invention showing a cross-sectional side view of a waffle iron with the heating element formed of conductive loaded resin-based material.

FIG. 12 illustrates a seventh preferred embodiment of the present invention showing a top internal view of a toaster with the heating elements formed of conductive loaded resin-based material.

FIG. 13 illustrates an eighth preferred embodiment of the present invention showing a cross-sectional side view of a grill with the heating elements formed of conductive loaded resin-based material.

FIG. 14 illustrates a ninth preferred embodiment of the present invention showing a cross-sectional side view of a tortilla press with the heating elements formed of conductive loaded resin-based material.

FIG. 15 illustrates a tenth preferred embodiment of the present invention showing a cross-sectional side view of a griddle with the heating elements formed of conductive loaded resin-based material.

### DESCRIPTION OF THE PREFERRED EMBODIMENTS

This invention relates to heating elements for cooking appliances molded of conductive loaded resin-based materials comprising micron conductive powders, micron conductive fibers, or a combination thereof, substantially homogenized within a base resin when molded.

The conductive loaded resin-based materials of the invention are base resins loaded with conductive materials, which then makes any base resin a conductor rather than an insulator. The resins provide the structural integrity to the molded part. The micron conductive fibers, micron conductive powders, or a combination thereof, are substantially homogenized within the resin during the molding process, providing the electrical, thermal, and/or acoustical continuity.

The conductive loaded resin-based materials can be molded, extruded or the like to provide almost any desired shape or size. The molded conductive loaded resin-based materials can also be cut, stamped, or vacuumed formed from an injection molded or extruded sheet or bar stock, over-molded, laminated, milled or the like to provide the desired shape and size. The thermal or electrical conductivity characteristics of heating elements for cooking appliances fabricated using conductive loaded resin-based materials depend on the composition of the conductive loaded resin-based materials, of which the loading or doping parameters can be adjusted, to aid in achieving the desired structural, electrical or other physical characteristics of the material. The selected materials used to fabricate the heating elements for cooking appliances are substantially homogenized together using molding techniques and or methods such as injection molding, over-molding, insert molding, thermo-set, protrusion, extrusion, calendaring, or the like. Characteristics related to 2D, 3D, 4D, and 5D designs, molding and electrical characteristics, include the physical and electrical advantages that can be achieved during the molding process of the actual parts and the polymer physics associated within the conductive networks within the molded part(s) or formed material(s).

In the conductive loaded resin-based material, electrons travel from point to point when under stress, following the path of least resistance. Most resin-based materials are insulators and represent a high resistance to electron passage. The doping of the conductive loading into the resin-based material alters the inherent resistance of the polymers. At a threshold concentration of conductive loading, the resistance through the combined mass is lowered enough to allow electron movement. Speed of electron movement depends on conductive loading concentration, that is, the separation between the conductive loading particles. Increasing conductive loading content reduces interparticle separation distance, and, at a critical distance known as the percolation point, resistance decreases dramatically and electrons move rapidly.

Resistivity is a material property that depends on the atomic bonding and on the microstructure of the material. The atomic microstructure material properties within the conductive loaded resin-based material are altered when molded into a structure. A substantially homogenized conductive microstructure of delocalized valance electrons is created. This microstructure provides sufficient charge carriers within the molded matrix structure. As a result, a low density, low resistivity, lightweight, durable, resin based polymer microstructure material is achieved. This material exhibits conductivity comparable to that of highly conductive metals such as silver, copper or aluminum, while maintaining the superior structural characteristics found in many plastics and rubbers or other structural resin based materials.

The use of conductive loaded resin-based materials in the fabrication of heating elements for cooking appliances significantly lowers the cost of materials and the design and manufacturing processes used to hold ease of close tolerances, by forming these materials into desired shapes and sizes. The heating elements can be manufactured into infinite shapes and sizes using conventional forming methods such as injection molding, over-molding, or extrusion, calendaring, or the like. The conductive loaded resin-based materials, when molded, typically but not exclusively produce a desirable usable range of resistivity from between about 5 and 25 ohms per square, but other resistivities can be achieved by varying the doping parameters and/or resin selection(s).

The conductive loaded resin-based materials comprise micron conductive powders, micron conductive fibers, or any combination thereof, which are substantially homogenized together within the base resin, during the molding process, yielding an easy to produce low cost, electrically conductive, close tolerance manufactured part or circuit. The resulting molded article comprises a three dimensional, continuous network of conductive loading and polymer matrix. Exemplary micron conductive powders include carbons, graphites, amines or the like, and/or of metal powders such as nickel, copper, silver, aluminum, nichrome, or plated or the like. The use of carbons or other forms of powders such as graphite(s) etc. can create additional low level electron exchange and, when used in combination with micron conductive fibers, creates a micron filler element within the micron conductive network of fiber(s) producing further electrical conductivity as well as acting as a lubricant for the molding equipment. Carbon nano-tubes may be added to the conductive loaded resin-based material. The addition of conductive powder to the micron conductive fiber loading may increase the surface conductivity of the molded part, particularly in areas where a skinning effect occurs during molding.

The micron conductive fibers may be metal fiber or metal plated fiber. Further, the metal plated fiber may be formed by plating metal onto a metal fiber or by plating metal onto a non-metal fiber. Exemplary metal fibers include, but are not limited to, stainless steel fiber, copper fiber, nickel fiber, silver fiber, aluminum fiber, nichrome fiber, or the like, or combinations thereof. Exemplary metal plating materials include, but are not limited to, copper, nickel, cobalt, silver, gold, palladium, platinum, ruthenium, rhodium, and nichrome, and alloys of thereof. Any platable fiber may be used as the core for a non-metal fiber. Exemplary non-metal fibers include, but are not limited to, carbon, graphite, polyester, basalt, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fibers in the present invention.

The structural material may be any polymer resin or combination of polymer resins. Non-conductive resins or inherently conductive resins may be used as the structural material. Conjugated polymer resins, complex polymer resins, and/or inherently conductive resins may be used as the structural material. The dielectric properties of the resin-based material will have a direct effect upon the final electrical performance of the conductive loaded resin-based material. Many different dielectric properties are possible depending on the chemical makeup and/or arrangement, such as linking, cross-linking or the like, of the polymer, co-polymer, monomer, ter-polymer, or homo-polymer material. Structural material can be, here given as examples and not as an exhaustive list, polymer resins produced by GE PLASTICS, Pittsfield, Mass., a range of other plastics produced by GE PLASTICS, Pittsfield, Mass., a range of other plastics produced by other manufacturers, silicones produced by GE SILICONES, Waterford, N.Y., or other flexible resin-based rubber compounds produced by other manufacturers.

The resin-based structural material loaded with micron conductive powders, micron conductive fibers, or in combination thereof can be molded, using conventional molding methods such as injection molding or over-molding, or extrusion, or compression molding, or calendaring, to create desired shapes and sizes. The molded conductive loaded resin-based materials can also be stamped, cut or milled as desired to form create the desired shape form factor(s) of the heating elements. The doping composition and directionality associated with the micron conductors within the loaded base resins can affect the electrical and structural characteristics of the heating elements and can be precisely controlled by mold designs, gating and or protrusion design(s) and or during the molding process itself. In addition; the resin base can be selected to obtain the desired thermal characteristics such as very high melting point or specific thermal conductivity.

A resin-based sandwich laminate could also be fabricated with random or continuous webbed micron stainless steel fibers or other conductive fibers, forming a cloth like material. The webbed conductive fiber can be laminated or the like to materials such as Teflon, Polyesters, or any resin-based flexible or solid material(s), which when discretely designed in fiber content(s), orientation(s) and shape(s), will produce a very highly conductive flexible cloth-like material. Such a cloth-like material could also be used in forming heating elements that could be embedded in a person's clothing as well as other resin materials such as rubber(s) or plastic(s). When using conductive fibers as a webbed conductor as part of a laminate or cloth-like material, the fibers may have diameters of between about 3 and 12 microns, typically between about 8 and 12 microns or in the range of about 10 microns, with length(s) that can be seamless or overlapping.

The conductive loaded resin-based material may also be formed into a prepreg laminate, cloth, or webbing. A laminate, cloth, or webbing of the conductive loaded resin-based material is first impregnated with a resin-based material. In various embodiments, the conductive loaded resin-based material is dipped, coated, sprayed, and/or extruded with resin-based material to cause the laminate, cloth, or webbing to adhere together in a prepreg grouping that is easy to handle. This prepreg is placed, or laid up, onto a form and is then heated to form a permanent bond. In another embodiment, the prepreg is laid up onto the impregnating resin while the resin is still wet and is then cured by heating or other means. In another embodiment, the wet lay-up is performed by laminating the conductive loaded resin-based prepreg over a honeycomb structure. In yet another embodiment, a wet prepreg is formed by spraying, dipping, or coating the conductive loaded resin-based material laminate, cloth, or webbing in high temperature capable paint.

Carbon fiber and resin-based composites are found to display unpredictable points of failure. In carbon fiber systems there is no elongation of the structure. By comparison, in the present invention, the conductive loaded resin-based material displays greater strength in the direction of elongation. As a result a structure formed of the conductive loaded resin-based material of the present invention will hold together even if crushed while a comparable carbon fiber composite will break into pieces.

The conductive loaded resin-based material of the present invention can be made resistant to corrosion and/or metal electrolysis by selecting micron conductive fiber and/or micron conductive powder and base resin that are resistant to corrosion and/or metal electrolysis. For example, if a corrosion/electrolysis resistant base resin is combined with stainless steel fiber and carbon fiber/powder, then a corrosion and/or metal electrolysis resistant conductive loaded resin-based material is achieved. Another additional and important feature of the present invention is that the conductive loaded resin-based material of the present invention may be made flame retardant. Selection of a flame-retardant (FR) base resin material allows the resulting product to exhibit flame retardant capability. This is especially important in heating elements for cooking appliances as described herein.

The substantially homogeneous mixing of micron conductive fiber and/or micron conductive powder and base resin described in the present invention may also be described as doping. That is, the substantially homogeneous mixing converts the typically non-conductive base resin material into a conductive material. This process is analogous to the doping process whereby a semiconductor material, such as silicon, can be converted into a conductive material through the introduction of donor/acceptor ions as is well known in the art of semiconductor devices. Therefore, the present invention uses the term doping to mean converting a typically non-conductive base resin material into a conductive material through the substantially homogeneous mixing of micron conductive fiber and/or micron conductive powder into a base resin.

As an additional and important feature of the present invention, the molded conductor loaded resin-based material exhibits excellent thermal dissipation characteristics. Therefore, heating elements for cooking appliances manufactured from the molded conductor loaded resin-based material can provide added thermal dissipation capabilities to the application. For example, heat can be dissipated from electrical devices physically and/or electrically connected to a heating element of the present invention.

As a significant advantage of the present invention, heating elements for cooking appliances constructed of the conductive loaded resin-based material can be easily interfaced to an electrical circuit or grounded. In one embodiment, a wire can be attached to a conductive loaded resin-based heating element via a screw that is fastened to the element. For example, a simple sheet-metal type, self tapping screw, when fastened to the material, can achieve excellent electrical connectivity via the conductive matrix of the conductive loaded resin-based material. To facilitate this approach a boss may be molded into the conductive loaded resin-based material to accommodate such a screw. Alternatively, if a solderable screw material, such as copper, is used, then a wire can be soldered to the screw that is embedded into the conductive loaded resin-based material. In another embodiment, the conductive loaded resin-based material is partly or completely plated with a metal layer. The metal layer forms excellent electrical conductivity with the conductive matrix. A connection of this metal layer to another circuit or to ground is then made. For example, if the metal layer is solderable, then a soldered connection may be made between the element and a grounding wire.

Where a metal layer is formed over the surface of the conductive loaded resin-based material, any of several techniques may be used to form this metal layer. This metal layer may be used for visual enhancement of the molded conductive loaded resin-based material article or to otherwise alter performance properties. Well-known techniques, such as electroless metal plating, electro metal plating, sputtering, metal vapor deposition, metallic painting, or the like, may be applied to the formation of this metal layer. If metal plating is used, then the resin-based structural material of the conductive loaded, resin-based material is one that can be metal plated. There are many of the polymer resins that can be plated with metal layers. For example, GE Plastics, SUPEC, VALOX, ULTEM, CYCOLAC, UGIKRAL, STYRON, CYCOLOY are a few resin-based materials that can be metal plated. Electroless plating is typically a multiple-stage chemical process where, for example, a thin copper layer is first deposited to form a conductive layer. This conductive layer is then used as an electrode for the subsequent plating of a thicker metal layer.

A typical metal deposition process for forming a metal layer onto the conductive loaded resin-based material is vacuum metallization. Vacuum metallization is the process where a metal layer, such as aluminum, is deposited on the conductive loaded resin-based material inside a vacuum chamber. In a metallic painting process, metal particles, such as silver, copper, or nickel, or the like, are dispersed in an acrylic, vinyl, epoxy, or urethane binder. Most resin-based materials accept and hold paint well, and automatic spraying systems apply coating with consistency. In addition, the excellent conductivity of the conductive loaded resin-based material of the present invention facilitates the use of extremely efficient, electrostatic painting techniques.

The conductive loaded resin-based material can be contacted in any of several ways. In one embodiment, a pin is embedded into the conductive loaded resin-based material by insert molding, ultrasonic welding, pressing, or other means. A connection with a metal wire can easily be made to this pin and results in excellent contact to the conductive loaded resin-based material. In another embodiment, a hole is formed in to the conductive loaded resin-based material either during the molding process or by a subsequent process step such as drilling, punching, or the like. A pin is then placed into the hole and is then ultrasonically welded to form a permanent mechanical and electrical contact. In yet another embodiment, a pin or a wire is soldered to the conductive loaded resin-based material. In this case, a hole is formed in the conductive loaded resin-based material either during the molding operation or by drilling, stamping, punching, or the like. A solderable layer is then formed in the hole. The solderable layer is preferably formed by metal plating. A conductor is placed into the hole and then mechanically and electrically bonded by point, wave, or reflow soldering.

Another method to provide connectivity to the conductive loaded resin-based material is through the application of a solderable ink film to the surface. One exemplary solderable ink is a combination of copper and solder particles in an epoxy resin binder. The resulting mixture is an active, screen-printable and dispensable material. During curing, the solder reflows to coat and to connect the copper particles and to thereby form a cured surface that is directly solderable without the need for additional plating or other processing steps. Any solderable material may then be mechanically and/or electrically attached, via soldering, to the conductive loaded resin-based material at the location of the applied solderable ink. Many other types of solderable inks can be used to provide this solderable surface onto the conductive loaded resin-based material of the present invention. Another exemplary embodiment of a solderable ink is a mixture of one or more metal powder systems with a reactive organic medium. This type of ink material is converted to solderable pure metal during a low temperature cure without any organic binders or alloying elements.

A ferromagnetic conductive loaded resin-based material may be formed of the present invention to create a magnetic or magnetizable form of the material. Ferromagnetic micron conductive fibers and/or ferromagnetic conductive powders are mixed with the base resin. Ferrite materials and/or rare earth magnetic materials are added as a conductive loading to the base resin. With the substantially homogeneous mixing of the ferromagnetic micron conductive fibers and/or micron conductive powders, the ferromagnetic conductive loaded resin-based material is able to produce an excellent low cost, low weight magnetize-able item. The magnets and magnetic devices of the present invention can be magnetized during or after the molding process. The magnetic strength of the magnets and magnetic devices can be varied by adjusting the amount of ferromagnetic micron conductive fibers and/or ferromagnetic micron conductive powders that are incorporated with the base resin. By increasing the amount of the ferromagnetic doping, the strength of the magnet or magnetic devices is increased. The substantially homogenous mixing of the conductive fiber network allows for a substantial amount of fiber to be added to the base resin without causing the structural integrity of the item to decline. The ferromagnetic conductive loaded resin-based magnets display the excellent physical properties of the base resin, including flexibility, moldability, strength, and resistance to environmental corrosion, along with excellent magnetic ability. In addition, the unique ferromagnetic conductive loaded resin-based material facilitates formation of items that exhibit excellent thermal and electrical conductivity as well as magnetism.

A high aspect ratio magnet is easily achieved through the use of ferromagnetic conductive micron fiber or through the combination of ferromagnetic micron powder with conductive micron fiber. The use of micron conductive fiber allows for molding articles with a high aspect ratio of conductive fiber to cross sectional area. If a ferromagnetic micron fiber is used, then this high aspect ratio translates into a high quality magnetic article. Alternatively, if a ferromagnetic micron powder is combined with micron conductive fiber, then the magnetic effect of the powder is effectively spread throughout the molded article via the network of conductive fiber such that an effective high aspect ratio molded magnetic article is achieved. The ferromagnetic conductive loaded resin-based material may be magnetized, after molding, by exposing the molded article to a strong magnetic field. Alternatively, a strong magnetic field may be used to magnetize the ferromagnetic conductive loaded resin-based material during the molding process.

The ferromagnetic conductive loading is in the form of fiber, powder, or a combination of fiber and powder. The micron conductive powder may be metal fiber or metal plated fiber. If metal plated fiber is used, then the core fiber is a platable material and may be metal or non-metal. Exemplary ferromagnetic conductive fiber materials include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive fiber materials. Exemplary ferromagnetic micron powder leached onto the conductive fibers include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive powder materials. A ferromagnetic conductive loading may be combined with a non-ferromagnetic conductive loading to form a conductive loaded resin-based material that combines excellent conductive qualities with magnetic capabilities.

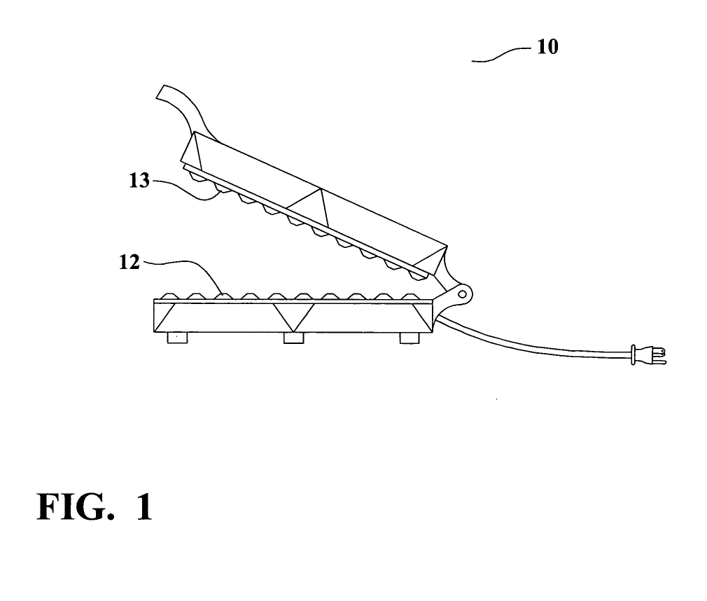

Referring now to FIG. 1, a first preferred embodiment of the present invention is illustrated. A waffle iron 10 having a lower resistive heating element 12 and upper resistive heating element 13 formed, in part, of the conductive loaded resin-based material of the present invention. The heating elements 12 and 13 are typically, though not necessarily, identical in size and shape.

Referring now to FIG. 11, as a sixth preferred embodiment of the present invention, a cross-sectional side view of a heating element 180 of the waffle iron is shown. In an exemplary method of formation, a heating element 182 is molded of the conductive loaded resin-based material described in the present invention by any convention molding method such as injection molding, extrusion, and the like. In one embodiment, the heating element 182 is molded into a relatively narrow strip and routed in a spiral shape or a serpentine shape from terminal to terminal.

In order to spread electrical current concentration at the points of contact between the electrical supply wiring 183 and the conductive loaded, resin-based material heating element, metal terminals 184 are formed along two opposite ends of the element to allow soldering points for the wire leads 183. In another embodiment, the edges of the conductive loaded resin-based heating element 182 are plated with a metal layer 184 to aid in current spreading. In one embodiment, this plated metal layer 184 is a solderable material such that the wire leads 183 can be soldered directly to this plated layer. If a solderable metal layer 184 is used, then the solderability may be further enhanced by first forming holes in the conductive loaded, resin-based material into which the solderable layer 184 is plated and, then, into which the supply wires 183 are soldered. In another embodiment, metal terminals 184 are crimped onto the heating element. The supply wires 183 are then soldered into the crimped metal terminals 184. In another embodiment, metal pins are inserted into the conductive loaded resin-based heating element 182 to form metal terminals 184.

The terminals 184 are connected to the electrical power supply 183 for the appliance. In one embodiment, alternating current (AC) electrical power, such as is available through the residential power service, is directly used to power the heating element 182. In another embodiment, direct current (DC) electrical power, such as is available from a battery or from a power converter connected to an AC supply, is used to power the heating element 182. A thermostatic control device, not shown, is also included in an embodiment of the present invention.

When power is supplied across the terminals 184 of the conductive loaded, resin-based material heating element 182, the element rapidly and evenly heats the heat plate 188. To contain the electrical current to within the element, a dielectric insulator 186 is formed over the heating element 182. In one embodiment, a high temperature capable resin-based material 186 is over-molded onto the heating element 182. In another embodiment, a high temperature capable paint 186 is applied over the heating element 182. In another embodiment, a mica or ceramic material 186 is formed onto or attached over the heating element 182 to provide electrical insulation while maintaining thermal conduction.

To further spread the heat delivered by the heating element 182, and to provide the distinctive cooking surface shape, a heat plate 188 is used. The heat plate 188 is held in contact with the heating element 182 with on the electrical dielectric 186 therebetween. In one embodiment, the heat plate 188 comprises a metal such as aluminum or iron. In another embodiment, the heat plate 188 comprises the conductive loaded, resin-based material. In this case, the conductive loaded, resin-based material provides substantial heat transfer for cooking while greatly reducing the weight of the heat plate 188. If the conductive loaded, resin-based material is used for the heat plate 188, then the heat plate 188 may be formed by any conventional molding method, such as injection molding or extrusion.

In one embodiment the heating plate 188 is coated with a non-stick material, such as polytetrafluoroethylene, or Teflon™. In one embodiment, a non-stick resin-based material is spray coated or over-molded onto the heating heat plate 188. If the conductive loaded, resin-based material is used for the heat plate 188, then the non-stick layer 190 may be over-molded onto the heat plate. In yet another embodiment the conductive loaded resin-based heating element uses non-stick resin-based material, such as polytetrafluoroethylene, as the base resin. In this case, the heat plate 188 combines a non-stick surface with excellent thermal conductivity.

The heating element 182 formed of the conductive loaded resin-based material of the present invention is an excellent thermal conductor as well as an electrical conductor. The heating element is particularly well suited for mobile applications, such as recreation vehicles, boats, etc., where low weight is ideal. While only the bottom heating section of the indoor waffle iron 180 is shown in FIG. 11, it is understood that the top heating section may be identical in construction. It is further understood that high temperature capable thermoplastic or thermosetting resin materials are used, as needed for temperature capability, for the base resin of the conductive loaded resin-based heating elements described in the present invention.

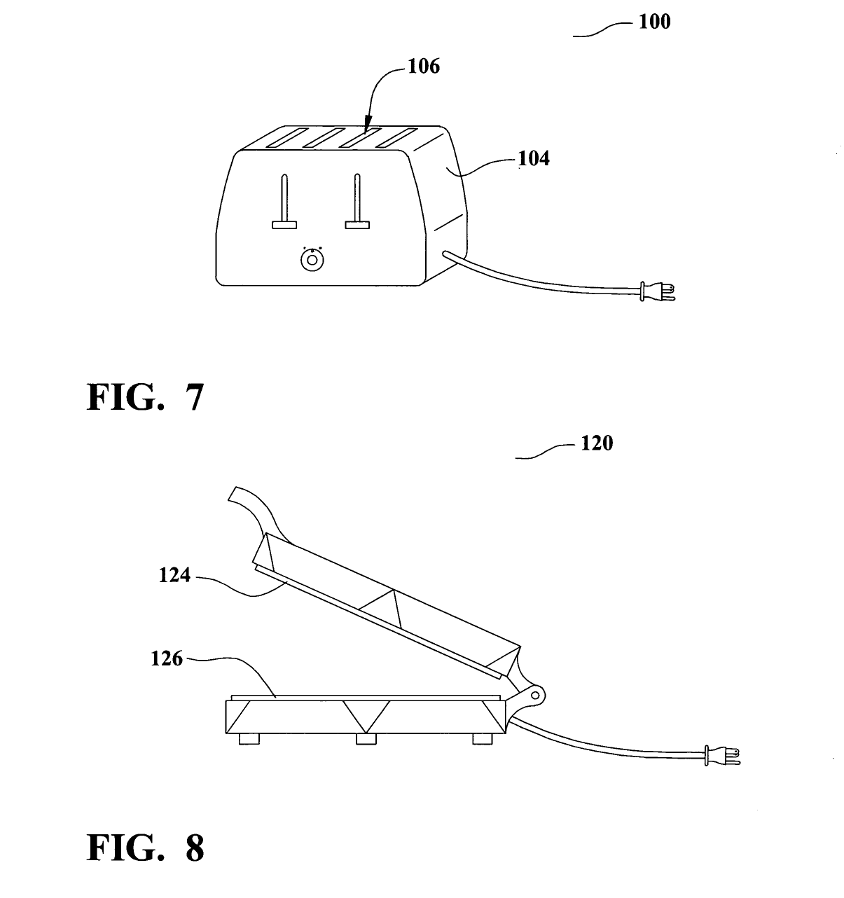

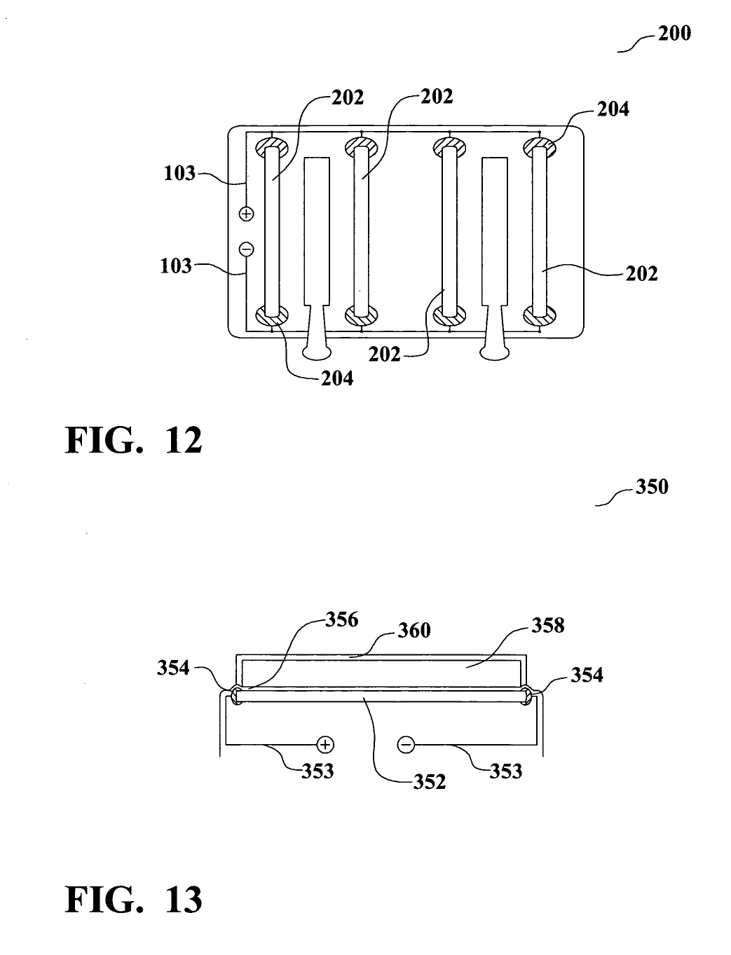

Referring now to FIG. 7, a second preferred embodiment 100 of the present invention is illustrated. A toaster 104 having the resistive heating elements 106 formed of the conductive loaded resin-based material of the present invention is illustrated. Referring now to FIG. 12, as a seventh preferred embodiment of the present invention an internal, top view 200 of the toaster is shown. A two slice toaster 200 is shown with four heating elements 202 formed of the conductive loaded resin-based material of the present invention. In an exemplary method of formation, the heating elements 202 are molded of the conductive loaded resin-based material described in the present invention by any convention molding method such as injection molding, extrusion, and the like. The flat panel resistive heating elements 204 formed of the conductive loaded resin-based material of the present invention will toast the bread at a more even consistency than coiled wire resistive heating elements. With the heat more evenly distributed to the bread, less electrical energy will be used and toasting will be done more quickly.

In order to spread electrical current concentration at the points of contact between the electrical supply wiring 203 and the conductive loaded, resin-based material heating elements 204, metal terminals 204 are formed along two opposite ends of the element to allow soldering points for the wire leads 203. In another embodiment, the edges of the conductive loaded resin-based heating elements 202 are plated with a metal layer 204 to aid in current spreading. In one embodiment, this plated metal layer 204 is a solderable material such that the wire leads 203 can be soldered directly to this plated layer. If a solderable metal layer 204 is used, then the solderability may be further enhanced by first forming holes in the conductive loaded, resin-based material into which the solderable layer 204 is plated and, then, into which the supply wires 203 are soldered. In another embodiment, metal terminals 204 are crimped onto the heating element. The supply wires 203 are then soldered into the crimped metal terminals 204. In another embodiment, metal pins are inserted into the conductive loaded resin-based heating elements 202 to form metal terminals 204.

In another embodiment an adjustment mechanism is added to allow for different thicknesses of bread while maintaining contact between the bread and the heating elements 202. In yet another embodiment an outer layer of electrically insulating resin-based material, not shown, is formed onto the conductive loaded, resin-based material by over-molding, coating, and the like. This electrically insulating layer protects the user from contacting the electrical circuit present in the heating elements 202.

The terminals 204 are connected to the electrical power supply 203 for the toaster. In one embodiment, alternating current (AC) electrical power, such as is available through the residential power service, is directly used to power the heating element 202. In another embodiment, direct current (DC) electrical power, such as is available from a battery or from a power converter connected to an AC supply, is used to power the heating element 202. A thermostatic control device, not shown, is also included in an embodiment of the present invention.

When power is supplied across the terminals 204 of the conductive loaded, resin-based material heating elements 202, the elements rapidly and evenly increase in temperature. To contain the electrical current to within each element, a dielectric insulator is formed over the heating elements 202. In one embodiment, a high temperature capable resin-based material is over-molded onto the heating elements 202. In another embodiment, a high temperature capable paint is applied over the heating elements 202. In another embodiment, a mica or ceramic material is formed onto or attached over the heating elements 202 to provide electrical insulation while maintaining thermal conduction.

The toaster heating elements 202 formed of the conductive loaded resin-based material of the present invention are excellent thermal conductors as well as electrical conductors. The toaster heating elements 202 are particularly well suited for mobile applications, such as recreation vehicles, boats, etc., where low weight is ideal. It is understood that high temperature capable thermoplastic or thermosetting resin materials are used, as needed for temperature capability, for the base resin of the conductive loaded resin-based heating elements described in the present invention.

Referring now to FIG. 8, a third preferred embodiment of the present invention is illustrated. A tortilla press 120 having the lower heating element 126 and the upper heating element 124 formed, in part, of the conductive loaded resin-based material of the present invention is illustrated. The heating elements 124 and 126 formed of the conductive loaded resin-based material of the present invention offer the advantage of lower weight and lowered production cost over traditional metal heating elements and cooking surfaces.

Referring now to FIG. 13, as an eighth preferred embodiment of the present invention, a cross-sectional side view of the lower part 350 of the tortilla press is shown. In an exemplary method of formation, a heating element 352 is molded of the conductive loaded resin-based material described in the present invention by any convention molding method such as injection molding, extrusion, and the like. In one embodiment, the heating element 352 is molded into a relatively narrow strip and routed in a spiral shape or a serpentine shape from terminal to terminal.

In order to spread electrical current concentration at the points of contact between the electrical supply wiring 353 and the conductive loaded, resin-based material heating element, metal terminals 354 are formed along two opposite ends of the element to allow soldering points for the wire leads 353. In another embodiment, the edges of the conductive loaded resin-based heating element 352 are plated with a metal layer 354 to aid in current spreading. In one embodiment, this plated metal layer 354 is a solderable material such that the wire leads 353 can be soldered directly to this plated layer. If a solderable metal layer 354 is used, then the solderability may be further enhanced by first forming holes in the conductive loaded, resin-based material into which the solderable layer 354 is plated and, then, into which the supply wires 353 are soldered. In another embodiment, metal terminals 354 are crimped onto the heating element. The supply wires 353 are then soldered into the crimped metal terminals 354. In another embodiment, metal pins are inserted into the conductive loaded resin-based heating element 352 to form metal terminals 354.

The terminals 354 are connected to the electrical power supply 353 for the appliance. In one embodiment, alternating current (AC) electrical power, such as is available through the residential power service, is directly used to power the heating element 352. In another embodiment, direct current (DC) electrical power, such as is available from a battery or from a power converter connected to an AC supply, is used to power the heating element 352. A thermostatic control device, not shown, is also included in an embodiment of the present invention.

When power is supplied across the terminals 354 of the conductive loaded, resin-based material heating element 352, the element rapidly and evenly heats the heat plate 358. To contain the electrical current to within the element, an insulator 356 is formed over the heating element 352. In one embodiment, a high temperature capable resin-based material 356 is over-molded onto the heating element 352. In another embodiment, a high temperature capable paint 356 is applied over the heating element 352. In another embodiment, a mica or ceramic material 356 is formed onto or attached over the heating element 352 to provide electrical insulation while maintaining thermal conduction.

To further spread the heat delivered by the heating element 352, and to provide a large cooking surface shape, a heat plate 358 is used. The heat plate 358 is held in contact with the heating element 352 with on the electrical dielectric insulator 356 therebetween. In one embodiment, the heat plate 358 comprises a metal such as aluminum or iron. In another embodiment, the heat plate 358 comprises the conductive loaded, resin-based material. In this case, the conductive loaded, resin-based material provides substantial heat transfer for cooking while greatly reducing the weight of the heat plate 358. If the conductive loaded, resin-based material is used for the heat plate 358, then the heat plate 358 may be formed by any conventional molding method, such as injection molding or extrusion.

In one embodiment the heating plate 358 is coated with a non-stick material, such as polytetrafluoroethylene, or Teflon™. In one embodiment, a non-stick resin-based material is spray coated or over-molded onto the heating heat plate 358. If the conductive loaded, resin-based material is used for the heat plate 358, then the non-stick layer 360 may be over-molded onto the heat plate. In yet another embodiment the conductive loaded resin-based heating element uses non-stick resin-based material, such as polytetrafluoroethylene, as the base resin. In this case, the heat plate 358 combines a non-stick surface with excellent thermal conductivity.

The heating element 352 formed of the conductive loaded resin-based material of the present invention is an excellent thermal conductor as well as an electrical conductor. The heating element is particularly well suited for mobile applications, such as recreation vehicles, boats, etc., where low weight is ideal. While only the bottom heating section 350 of the tortilla press is shown in FIG. 13, it is understood that the top heating section may be identical in construction. It is further understood that high temperature capable thermoplastic or thermosetting resin materials are used, as needed for temperature capability, for the base resin of the conductive loaded resin-based heating elements described in the present invention.

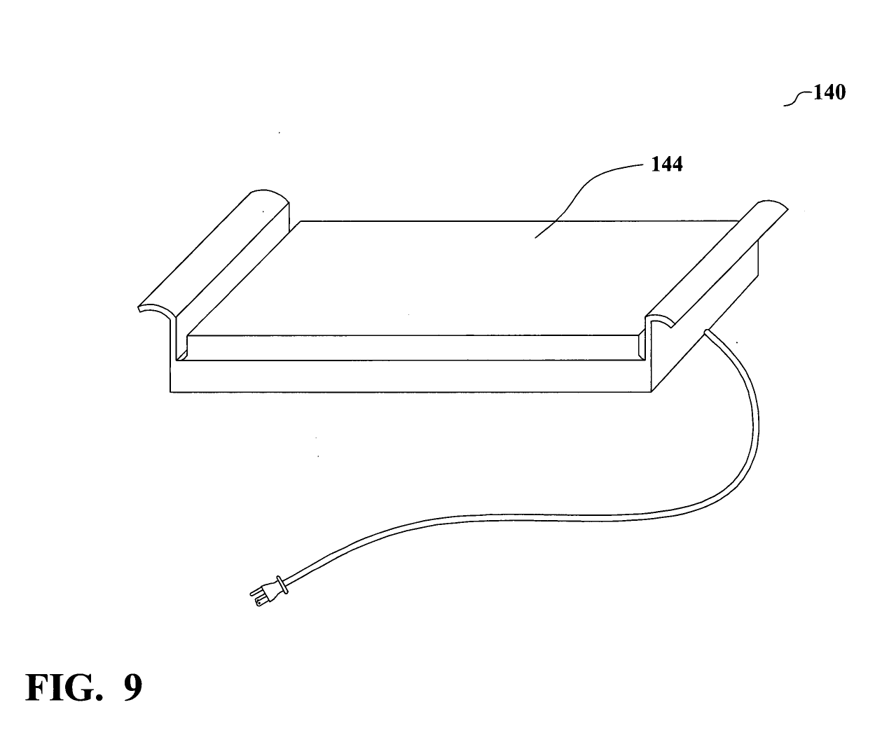

Referring now to FIG. 9, a fourth preferred embodiment of the present invention is illustrated. A griddle 140 with a heating element comprising, in part, the conductive loaded resin-based material of the present invention is shown. The griddle 140 shown in this embodiment is less costly to manufacture than a griddle with a metal heating element and can be formed in any desired shape or size.

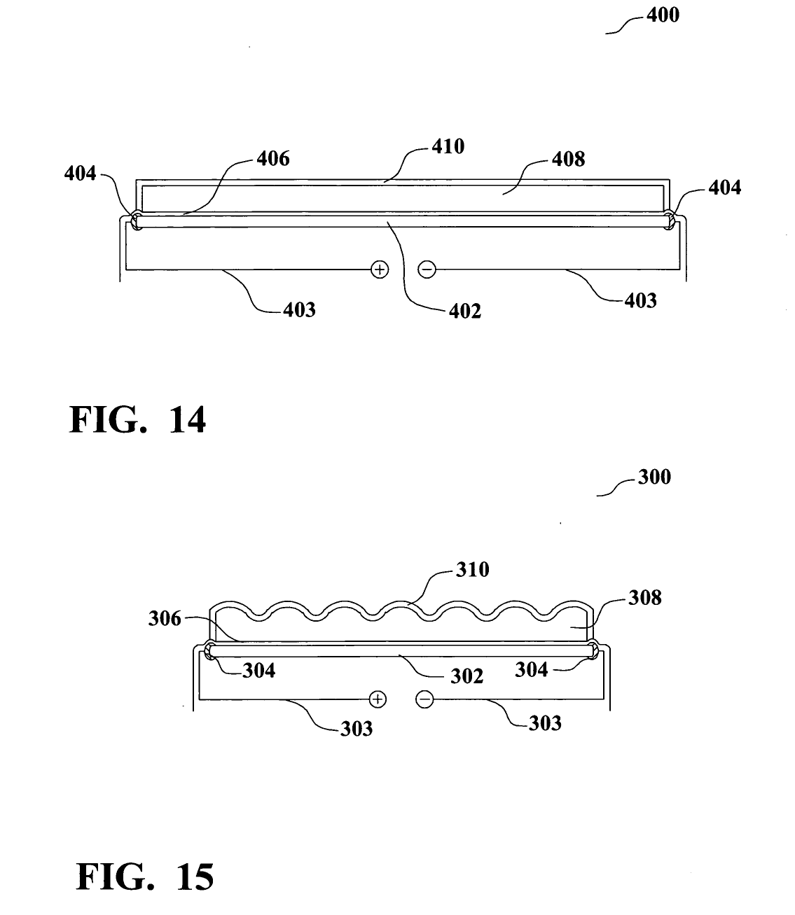

Referring now to FIG. 14, as a ninth preferred embodiment of the present invention, a cross-sectional side view 400 of the griddle is shown. In an exemplary method of formation, a heating element 402 is molded of the conductive loaded resin-based material described in the present invention by any convention molding method such as injection molding, extrusion, and the like. In one embodiment, the heating element 402 is molded into a relatively narrow strip and routed in a spiral shape or a serpentine shape from terminal to terminal.

In order to spread electrical current concentration at the points of contact between the electrical supply wiring 403 and the conductive loaded, resin-based material heating element, metal terminals 404 are formed along two opposite ends of the element to allow soldering points for the wire leads 403. In another embodiment, the edges of the conductive loaded resin-based heating element 402 are plated with a metal layer 404 to aid in current spreading. In one embodiment, this plated metal layer 404 is a solderable material such that the wire leads 403 can be soldered directly to this plated layer. If a solderable metal layer 404 is used, then the solderability may be further enhanced by first forming holes in the conductive loaded, resin-based material into which the solderable layer 404 is plated and, then, into which the supply wires 403 are soldered. In another embodiment, metal terminals 404 are crimped onto the heating element. The supply wires 403 are then soldered into the crimped metal terminals 404. In another embodiment, metal pins are inserted into the conductive loaded resin-based heating element 402 to form metal terminals 404.

The terminals 404 are connected to the electrical power supply 403 for the appliance. In one embodiment, alternating current (AC) electrical power, such as is available through the residential power service, is directly used to power the heating element 402. In another embodiment, direct current (DC) electrical power, such as is available from a battery or from a power converter connected to an AC supply, is used to power the heating element 402. A thermostatic control device, not shown, is also included in an embodiment of the present invention.

When power is supplied across the terminals 404 of the conductive loaded, resin-based material heating element 402, the element rapidly and evenly heats the heat plate 408. To contain the electrical current to within the element, an insulator 406 is formed over the heating element 402. In one embodiment, a high temperature capable resin-based material 406 is over-molded onto the heating element 402. In another embodiment, a high temperature capable paint 406 is applied over the heating element 402. In another embodiment, a mica or ceramic material 406 is formed onto or attached over the heating element 402 to provide electrical insulation while maintaining thermal conduction.

To further spread the heat delivered by the heating element 402, and to provide a large cooking surface shape, a heat plate 408 is used. The heat plate 408 is held in contact with the heating element 402 with on the electrical insulator 406 therebetween. In one embodiment, the heat plate 408 comprises a metal such as aluminum or iron. In another embodiment, the heat plate 408 comprises the conductive loaded, resin-based material. In this case, the conductive loaded, resin-based material provides substantial heat transfer for cooking while greatly reducing the weight of the heat plate 408. If the conductive loaded, resin-based material is used for the heat plate 408, then the heat plate 408 may be formed by any conventional molding method, such as injection molding or extrusion.

In one embodiment the heating plate 408 is coated with a non-stick material, such as polytetrafluoroethylene, or Teflon™. In one embodiment, a non-stick resin-based material is spray coated or over-molded onto the heating heat plate 408. If the conductive loaded, resin-based material is used for the heat plate 408, then the non-stick layer 410 may be over-molded onto the heat plate. In yet another embodiment the conductive loaded resin-based heating element uses non-stick resin-based material, such as polytetrafluoroethylene, as the base resin. In this case, the heat plate 408 combines a non-stick surface with excellent thermal conductivity.

The heating element 402 formed of the conductive loaded resin-based material of the present invention is an excellent thermal conductor as well as an electrical conductor. The heating element is particularly well suited for mobile applications, such as recreation vehicles, boats, etc., where low weight is ideal. It is further understood that high temperature capable thermoplastic or thermosetting resin materials are used, as needed for temperature capability, for the base resin of the conductive loaded resin-based heating elements described in the present invention.

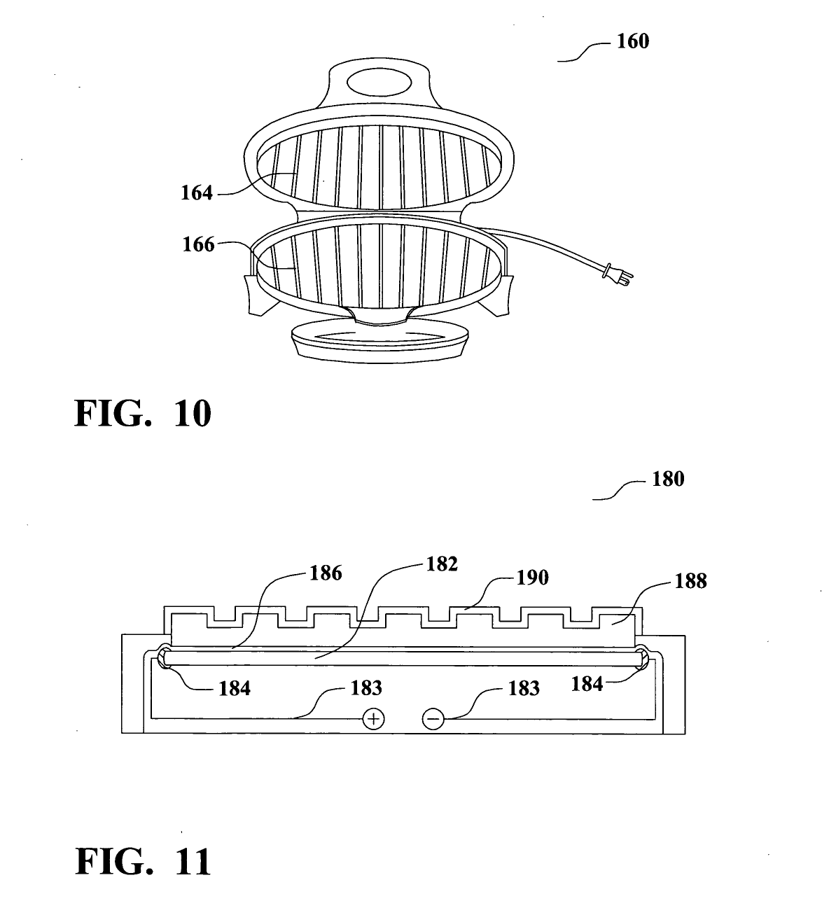

Referring now to FIG. 10, a fifth preferred embodiment of the present invention is illustrated. An indoor electric grill 160 is shown with the top heating element 164 and the bottom heating element 166 comprising in part of the conductive loaded resin-based material of the present invention. As mentioned previously, a more even cooking temperature is realized with the heating elements of the conductive loaded resin-based material of the present invention. In particular, hot or cold spots may be created by a heating wire or coil. In the present invention, these hot/cold spots are eliminated because the entire cooking area is, or is in contact with, the planar heating element. A further detailed illustration and description is shown in FIG. 15.

Referring now to FIG. 15, as a tenth preferred embodiment of the present invention, a cross-sectional side view 300 of the griddle is shown. In an exemplary method of formation, a heating element 302 is molded of the conductive loaded resin-based material described in the present invention by any convention molding method such as injection molding, extrusion, and the like. In one embodiment, the heating element 302 is molded into a relatively narrow strip and routed in a spiral shape or a serpentine shape from terminal to terminal.

In order to spread electrical current concentration at the points of contact between the electrical supply wiring 303 and the conductive loaded, resin-based material heating element, metal terminals 304 are formed along two opposite ends of the element to allow soldering points for the wire leads 303. In another embodiment, the edges of the conductive loaded resin-based heating element 302 are plated with a metal layer 304 to aid in current spreading. In one embodiment, this plated metal layer 304 is a solderable material such that the wire leads 303 can be soldered directly to this plated layer. If a solderable metal layer 304 is used, then the solderability may be further enhanced by first forming holes in the conductive loaded, resin-based material into which the solderable layer 304 is plated and, then, into which the supply wires 303 are soldered. In another embodiment, metal terminals 304 are crimped onto the heating element. The supply wires 303 are then soldered into the crimped metal terminals 304. In another embodiment, metal pins are inserted into the conductive loaded resin-based heating element 402 to form metal terminals 404.

The terminals 304 are connected to the electrical power supply 303 for the appliance. In one embodiment, alternating current (AC) electrical power, such as is available through the residential power service, is directly used to power the heating element 302. In another embodiment, direct current (DC) electrical power, such as is available from a battery or from a power converter connected to an AC supply, is used to power the heating element 302. A thermostatic control device, not shown, is also included in an embodiment of the present invention.

When power is supplied across the terminals 304 of the conductive loaded, resin-based material heating element 302, the element rapidly and evenly heats the heat plate 308. To contain the electrical current to within the element, a dielectric insulator 306 is formed over the heating element 302. In one embodiment, a high temperature capable resin-based material 306 is over-molded onto the heating element 302. In another embodiment, a high temperature capable paint 306 is applied over the heating element 302. In another embodiment, a mica or ceramic material 306 is formed onto or attached over the heating element 302 to provide electrical insulation while maintaining thermal conduction.

To further spread the heat delivered by the heating element 302, and to provide a large cooking surface shape, a heat plate 308 is used. The heat plate 308 is held in contact with the heating element 302 with on the electrical insulator 306 therebetween. In one embodiment, the heat plate 308 comprises a metal such as aluminum or iron. In another embodiment, the heat plate 308 comprises the conductive loaded, resin-based material. In this case, the conductive loaded, resin-based material provides substantial heat transfer for cooking while greatly reducing the weight of the heat plate 308. If the conductive loaded, resin-based material is used for the heat plate 308, then the heat plate 308 may be formed by any conventional molding method, such as injection molding or extrusion.

In one embodiment the heating plate 308 is coated with a non-stick material, such as polytetrafluoroethylene, or Teflon™. In one embodiment, a non-stick resin-based material is spray coated or over-molded onto the heating heat plate 308. If the conductive loaded, resin-based material is used for the heat plate 308, then the non-stick layer 310 may be over-molded onto the heat plate. In yet another embodiment the conductive loaded resin-based heating element uses non-stick resin-based material, such as polytetrafluoroethylene, as the base resin. In this case, the heat plate 408 combines a non-stick surface with excellent thermal conductivity.

The heating element 302 formed of the conductive loaded resin-based material of the present invention is an excellent thermal conductor as well as an electrical conductor. The heating element is particularly well suited for mobile applications, such as recreation vehicles, boats, etc., where low weight is ideal. While only the bottom heating section 300 of the tortilla press is shown in FIG. 15, it is understood that the top heating section may be identical in construction. It is further understood that high temperature capable thermoplastic or thermosetting resin materials are used, as needed for temperature capability, for the base resin of the conductive loaded resin-based heating elements described in the present invention.

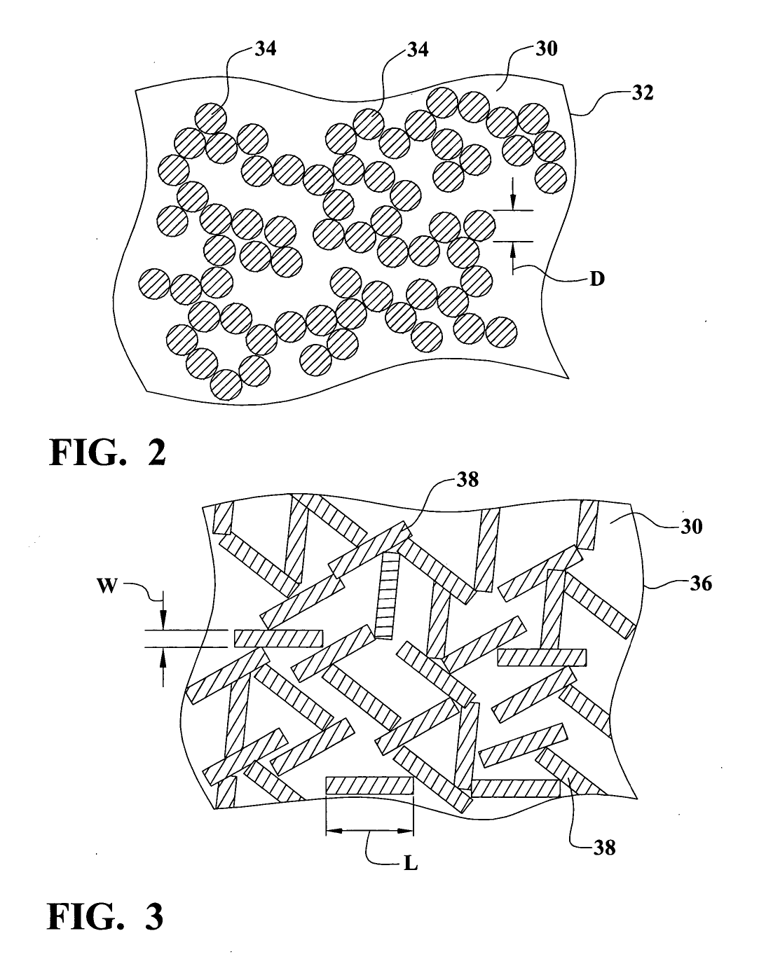

The conductive loaded resin-based material of the present invention typically comprises a micron powder(s) of conductor particles and/or in combination of micron fiber(s) substantially homogenized within a base resin host. FIG. 2 shows cross section view of an example of conductor loaded resin-based material 32 having powder of conductor particles 34 in a base resin host 30. In this example the diameter D of the conductor particles 34 in the powder is between about 3 and 12 microns.

FIG. 3 shows a cross section view of an example of conductor loaded resin-based material 36 having conductor fibers 38 in a base resin host 30. The conductor fibers 38 have a diameter of between about 3 and 12 microns, typically in the range of 10 microns or between about 8 and 12 microns, and a length of between about 2 and 14 millimeters. The micron conductive fibers 38 may be metal fiber or metal plated fiber. Further, the metal plated fiber may be formed by plating metal onto a metal fiber or by plating metal onto a non-metal fiber. Exemplary metal fibers include, but are not limited to, stainless steel fiber, copper fiber, nickel fiber, silver fiber, aluminum fiber, nichrome fiber, or the like, or combinations thereof. Exemplary metal plating materials include, but are not limited to, copper, nickel, cobalt, silver, gold, palladium, platinum, ruthenium, rhodium, and nichrome, and alloys of thereof. Any platable fiber may be used as the core for a non-metal fiber. Exemplary non-metal fibers include, but are not limited to, carbon, graphite, polyester, basalt, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fibers in the present invention.

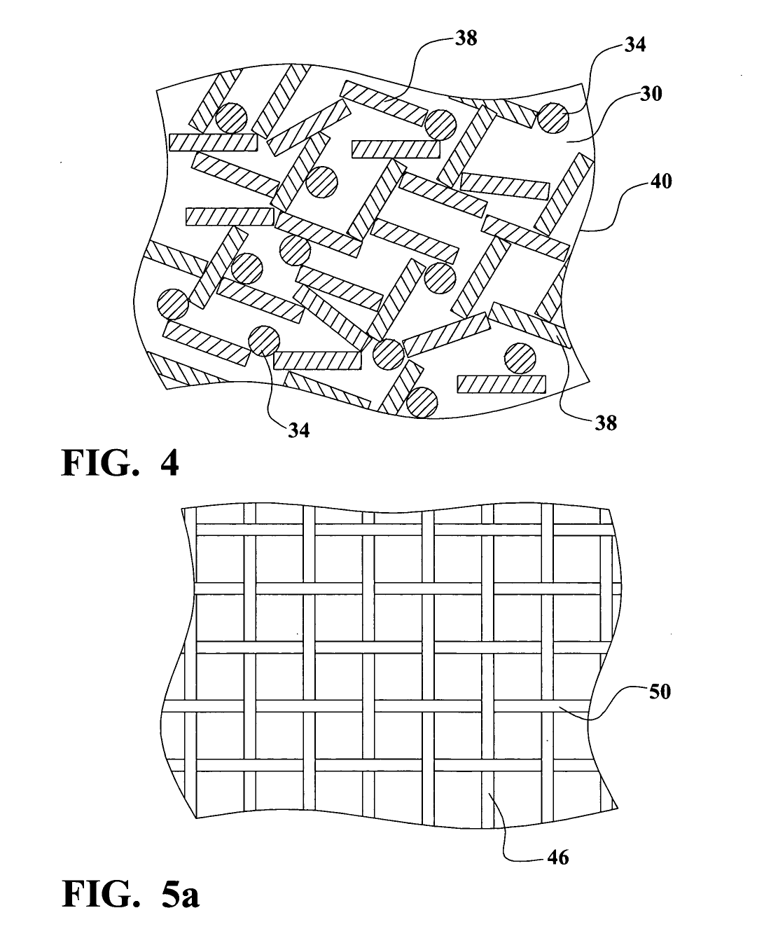

These conductor particles and/or fibers are substantially homogenized within a base resin. As previously mentioned, the conductive loaded resin-based materials have a sheet resistance between about 5 and 25 ohms per square, though other values can be achieved by varying the doping parameters and/or resin selection. To realize this sheet resistance the weight of the conductor material comprises between about 20% and about 50% of the total weight of the conductive loaded resin-based material. More preferably, the weight of the conductive material comprises between about 20% and about 40% of the total weight of the conductive loaded resin-based material. More preferably yet, the weight of the conductive material comprises between about 25% and about 35% of the total weight of the conductive loaded resin-based material. Still more preferably yet, the weight of the conductive material comprises about 30% of the total weight of the conductive loaded resin-based material. Stainless Steel Fiber of 6-12 micron in diameter and lengths of 4-6 mm and comprising, by weight, about 30% of the total weight of the conductive loaded resin-based material will produce a very highly conductive parameter, efficient within any EMF, thermal, acoustic, or electronic spectrum. Referring now to FIG. 4, another preferred embodiment of the present invention is illustrated where the conductive materials comprise a combination of both conductive powders 34 and micron conductive fibers 38 substantially homogenized together within the resin base 30 during a molding process.

Referring now to FIGS. 5a and 5b, a preferred composition of the conductive loaded, resin-based material is illustrated. The conductive loaded resin-based material can be formed into fibers or textiles that are then woven or webbed into a conductive fabric. The conductive loaded resin-based material is formed in strands that can be woven as shown. FIG. 5a shows a conductive fabric 42 where the fibers are woven together in a two-dimensional weave 46 and 50 of fibers or textiles. FIG. 5b shows a conductive fabric 42′ where the fibers are formed in a webbed arrangement. In the webbed arrangement, one or more continuous strands of the conductive fiber are nested in a random fashion. The resulting conductive fabrics or textiles 42, see FIG. 5a, and 42′, see FIG. 5b, can be made very thin, thick, rigid, flexible or in solid form(s).

Similarly, a conductive, but cloth-like, material can be formed using woven or webbed micron stainless steel fibers, or other micron conductive fibers. These woven or webbed conductive cloths could also be sandwich laminated to one or more layers of materials such as Polyester(s), Teflon(s), Kevlar(s) or any other desired resin-based material(s). This conductive fabric may then be cut into desired shapes and sizes.

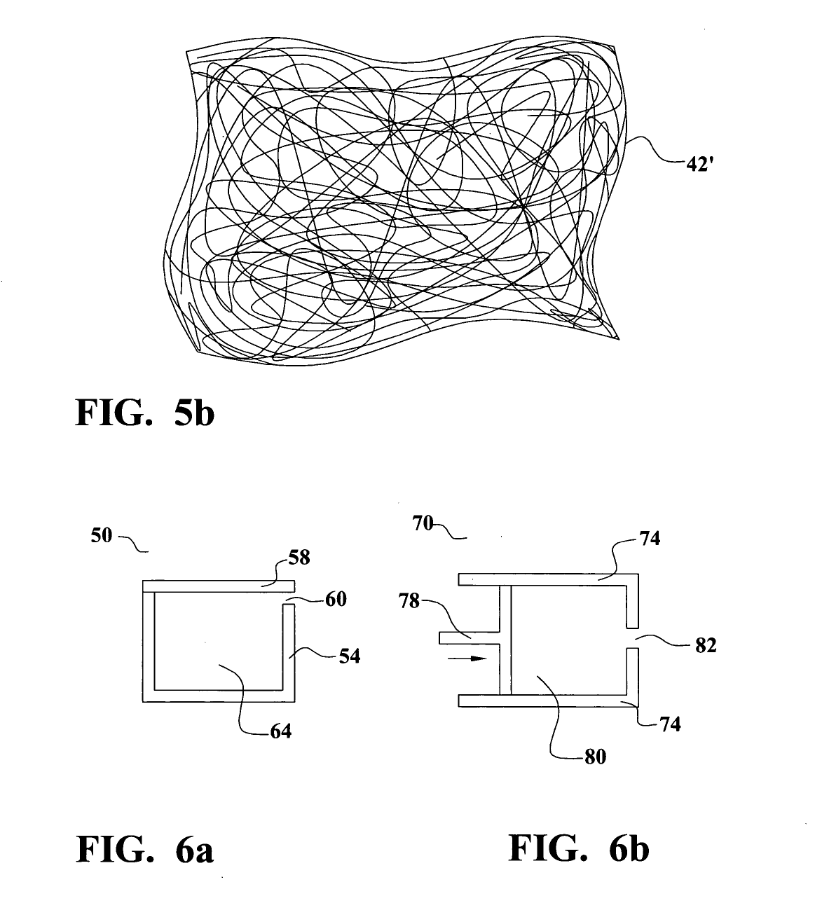

Heating elements for cooking appliances formed from conductive loaded resin-based materials can be formed or molded in a number of different ways including injection molding, extrusion, calendaring, or chemically induced molding or forming. FIG. 6a shows a simplified schematic diagram of an injection mold showing a lower portion 54 and upper portion 58 of the mold 50. Conductive loaded blended resin-based material is injected into the mold cavity 64 through an injection opening 60 and then the substantially homogenized conductive material cures by thermal reaction. The upper portion 58 and lower portion 54 of the mold are then separated or parted and the element is removed.

FIG. 6b shows a simplified schematic diagram of an extruder 70 for forming heating elements for cooking appliances using extrusion. Conductive loaded resin-based material(s) is placed in the hopper 80 of the extrusion unit 74. A piston, screw, press or other means 78 is then used to force the thermally molten or a chemically induced curing conductive loaded resin-based material through an extrusion opening 82 which shapes the thermally molten curing or chemically induced cured conductive loaded resin-based material to the desired shape. The conductive loaded resin-based material is then fully cured by chemical reaction or thermal reaction to a hardened or pliable state and is ready for use. Thermoplastic or thermosetting resin-based materials and associated processes may be used in molding the conductive loaded resin-based articles of the present invention.

The advantages of the present invention may now be summarized. An effective heating element for a cooking appliance is achieved. A method to form a heating element for a cooking appliance is achieved. The heating element is molded of conductive loaded resin-based materials. A cooking appliance comprising a conductive loaded resin-based heating element is described. A toaster, a waffle iron, and a tortilla press are formed with conductive loaded resin-based heating elements. A griddle and an indoor grill are formed with conductive loaded resin-based heating elements. The electrical or thermal characteristics or the visual characteristics of the heating element for a cooking appliance molded of conductive loaded resin-based material can be altered can be altered by forming a metal layer over the conductive loaded resin-based material. Methods are provided to fabricate a heating element for a cooking appliance from a conductive loaded resin-based material incorporating various forms of the material.

As shown in the preferred embodiments, the novel methods and devices of the present invention provide an effective and manufacturable alternative to the prior art.

While the invention has been particularly shown and described with reference to the preferred embodiments thereof, it will be understood by those skilled in the art that various changes in form and details may be made without departing from the spirit and scope of the invention.

What is claimed is:

1. A cooking appliance device comprising:
a heating element comprising a conductive loaded, resin-based material comprising conductive materials in a base resin host; and
a heat plate contacting said heating element on a first surface and having a second surface useful for cooking.

2. The device according to claim 1 wherein the percent by weight of said conductive materials is between about 20% and about 50% of the total weight of said conductive loaded resin-based material.

3. The device according to claim 1 wherein said conductive materials comprise micron conductive fiber.

4. The device according to claim 2 wherein said conductive materials further comprise conductive powder.

5. The device according to claim 1 wherein said conductive materials are metal.

6. The device according to claim 1 wherein said conductive materials comprise an inner core with an outer metal layer.

7. The device according to claim 1 further comprising metal terminals on opposite edges of said heating element.

8. The device according to claim 1 wherein said metal terminals comprise metal plating on said conductive loaded resin-based material.

9. The device according to claim 8 wherein said metal plating is solderable.

10. The device according to claim 1 further comprising a resin-based insulating layer between said heating element and said heat plate.

11. The device according to claim 1 wherein said heat plate comprises said conductive loaded, resin-based material.

12. A cooking appliance device comprising:
a heating element comprising a conductive loaded, resin-based material comprising micron conductive fiber in a base resin host wherein the percent by weight of said micron conductive fiber is between 20% and 50% of the total weight; and
a heat plate contacting said heating element on a first surface and having a second surface useful for cooking.

13. The device according to claim 12 wherein said micron conductive fiber is stainless steel.

14. The device according to claim 12 further comprising micron conductive powder.

15. The device according to claim 12 further comprising:
a second heating element comprising said conductive loaded, resin-based material; and
a second heat plate contacting said second heating element on a first surface and having a second surface useful for cooking wherein said first and second heat plates clamp around a food item.

16. The device according to claim 12 wherein said heat plate further comprises a non-stick coating.

17. A method to form a cooking appliance, said method comprising:
providing a conductive loaded, resin-based material comprising micron conductive fiber in a resin-based host;
providing a heat plate;
molding said conductive loaded, resin-based material into a heating element; and
contacting said heat plate and said heating element.

18. The method according to claim 17 wherein the percent by weight of said micron conductive fiber is between about 20% and about 50% of the total weight of said conductive loaded resin-based material.

19. The method according to claim 17 wherein further comprising micron conductive powder.

20. The method according to claim 17 wherein said micron conductive fiber is metal.

21. The method according to claim 17 wherein said micron conductive fiber comprises an inner core with an outer metal layer.

22. The method according to claim 17 further comprising forming a resin-based insulating layer between said heating element and said heat plate

23. The method according to claim 17 further comprising forming metal terminals on opposite edges of said heating element.

24. The method according to claim 23 wherein said step of forming metal terminals comprises plating a metal layer onto said conductive loaded resin-based material.

25. The method according to claim 24 wherein said metal layer is solderable.

26. The method according to claim 17 further comprising painting a high temperature paint layer onto said heating element.

27. The method according to claim 17 wherein said conductive loaded, resin-based material further comprises a ferromagnetic material such that said conductive loaded, resin-based material is magnetic or is magnetizable.

28. The method according to claim 17 wherein said heat plate comprises said conductive loaded, resin-based material.

29. The method according to claim 17 wherein said step of molding comprises:
injecting said conductive loaded, resin-based material into a mold;
curing said conductive loaded, resin-based material; and
removing said conductive fastening device from said mold.

30. The method according to claim 17 wherein said step of molding comprises:
loading said conductive loaded, resin-based material into a chamber;
extruding said conductive loaded, resin-based material out of said chamber through a shaping outlet; and
curing said conductive loaded, resin-based material to form said conductive fastening device.
